(19) United States
(12) Patent Application Publication
(10) Pub. No.: US 2020/0379805 A1
(43) Pub. Date: Dec. 3, 2020

(54) AUTOMATED CLOUD-EDGE STREAMING WORKLOAD DISTRIBUTION AND BIDIRECTIONAL MIGRATION WITH LOSSLESS, ONCE-ONLY PROCESSING

(71) Applicant: Microsoft Technology Licensing, LLC, Redmond, WA (US)

(72) Inventors: Todd R. Porter, Seattle, WA (US); Alexander Alperovich, Redmond, WA (US); Krishna Gyana Mamidipaka, Redmond, WA (US)

(21) Appl. No.: 16/426,993

(22) Filed: May 30, 2019

(51) Int. Cl. G06F 9/50; G06F 16/2455; G06F 16/2458

(52) U.S. Cl. CPC G06F 9/505; G06F 16/2471; G06F 16/24568; G06F 9/5061

(57) ABSTRACT

Methods, systems, and computer program products are described herein for automated cloud-edge workload distribution and bidirectional migration with lossless, once-only data stream processing. A cloud service may provide workload and bidirectional migration management between cloud and edge to provide once-only processing of data streams before and after migration. Migrated logic nodes may begin processing data streams where processing stopped at source logic nodes before migration without data loss or repetition, for example, by migrating and using anchors in pull-based stream processing. Query logic implementing customer queries of data streams may be distributed to edge and/or cloud devices based on placement criteria. Query logic may be migrated from source to target edge and/or cloud devices based on migration criteria.

### BACKGROUND

Cloud computing is a form of network-accessible computing that shares private and/or public computer processing resources and data over one or more networks (e.g. the Internet). Microsoft Azure® is an example of one cloud computing service. Cloud computing may provide on-demand access to a shared pool of configurable computing resources, such as computer networks, servers, storage, applications, services, virtual machines and/or containers. Cloud services may include, for example, infrastructure as a service (IaaS), platform as a service (PaaS), software as a service (SaaS), backend as a service (BaaS), serverless computing and/or function as a service (FaaS). A cloud service provider may provide service to a customer (e.g. tenant) under a service level agreement (SLA), which may specify performance guarantees, a maximum number of resources that may be allocated to the tenant and associated costs. Cloud service costs may be associated with peak usage (e.g. maximum scale out) of resources to accomplish computing tasks, whether a maximum number of resources are used ad hoc or reserved by a tenant.

Cloud computing may include stream processing, where multiple data streams from multiple sources may be processed in real time. Microsoft Azure® Stream Analytics is an example of an event-processing engine that may be configured (e.g. by customers) to process multiple data streams from various sources (e.g. Internet of Things (IoT) devices, sensors, web sites, social media feeds, applications, and so on). Customers may specify stream processing logic (e.g. business logic) in the form of queries provided to Azure Stream Analytics.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and computer program products are described herein for automated cloud-edge streaming workload distribution and bidirectional migration with lossless, once-only data stream processing. A cloud service may provide workload and bidirectional migration management between cloud and edge to provide once-only processing of data streams before and after migration. Migrated logic nodes may begin processing data streams where processing stopped at source logic nodes before migration without data loss or repetition, for example, by migrating and using anchors in pull-based stream processing. Query logic implementing customer queries of data streams may be distributed to edge and/or cloud devices based on placement criteria. Query logic may be migrated from source to target edge and/or cloud devices based on migration criteria.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

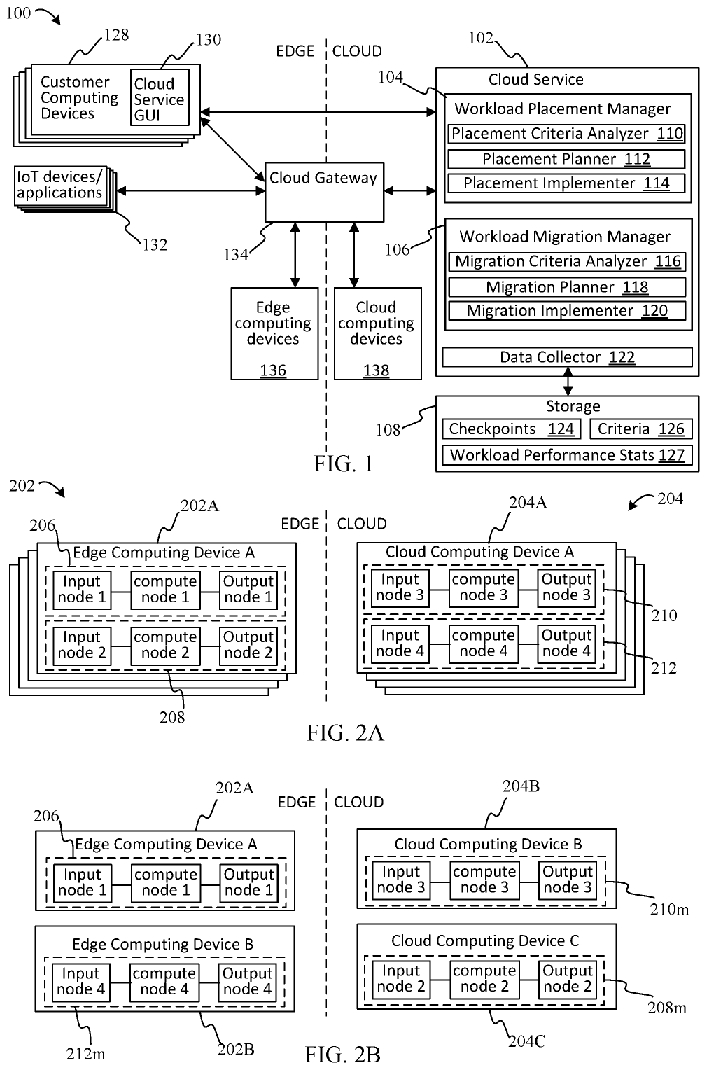

FIG. 1 is a block diagram of an example system for automated cloud-edge streaming workload distribution and bidirectional migration with lossless, once-only data stream processing in accordance with an example embodiment.

FIG. 2A is a block diagram of example data streaming workload placement in accordance with an example embodiment.

FIG. 2B is a block diagram of example data streaming workload migration in accordance with an example embodiment.

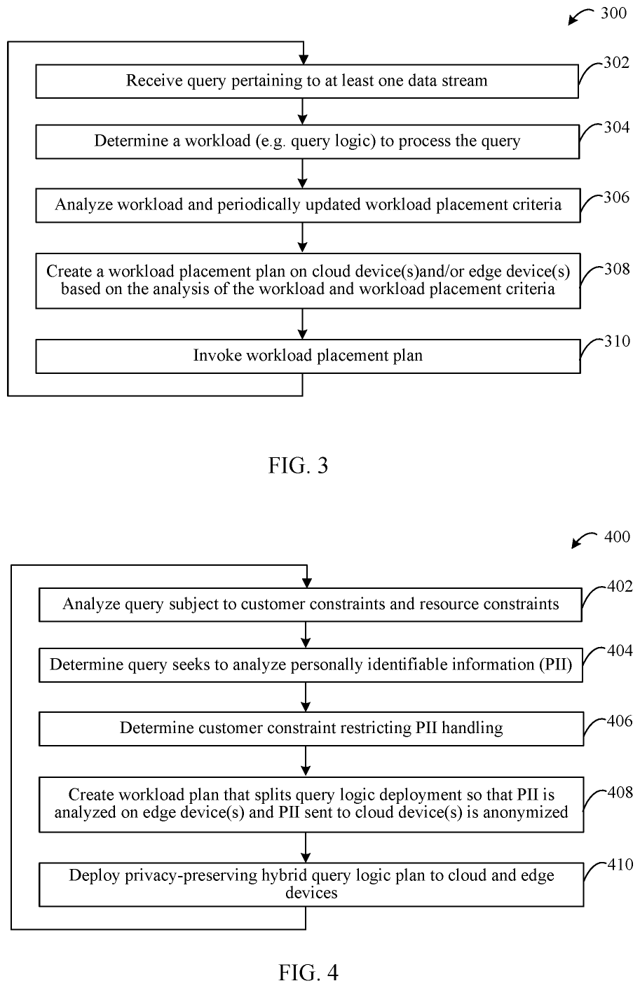

FIG. 3 is a flowchart of an example method for data streaming workload placement in accordance with an example embodiment.

FIG. 4 is a flowchart of an example method for data streaming workload placement in accordance with an example embodiment.

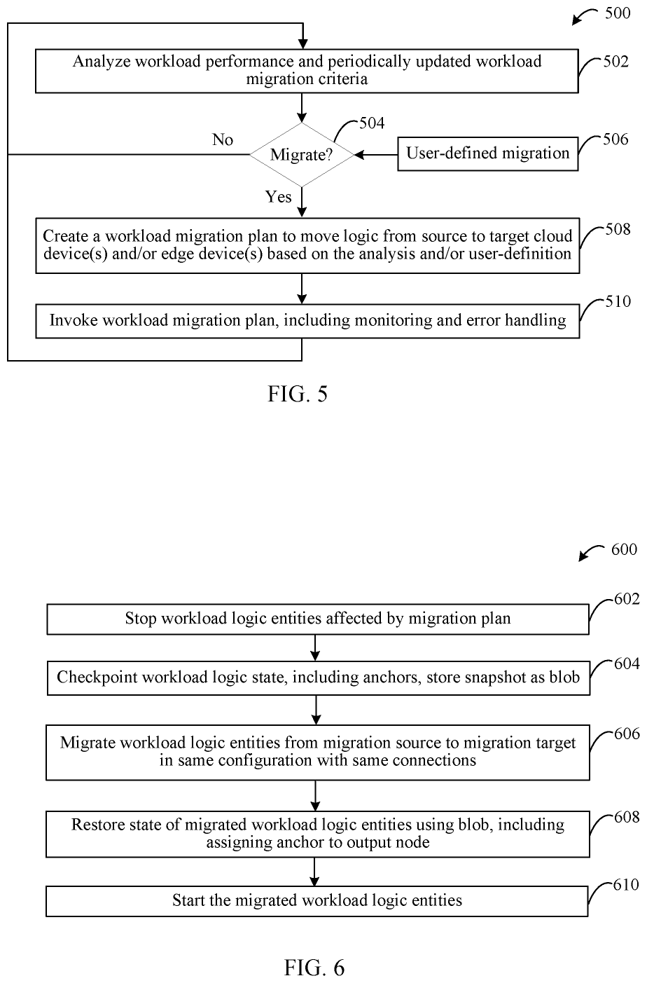

FIG. 5 is a flowchart of an example method for data streaming workload migration in accordance with an example embodiment.

FIG. 6 is a flowchart of an example method for data streaming workload migration in accordance with an example embodiment.

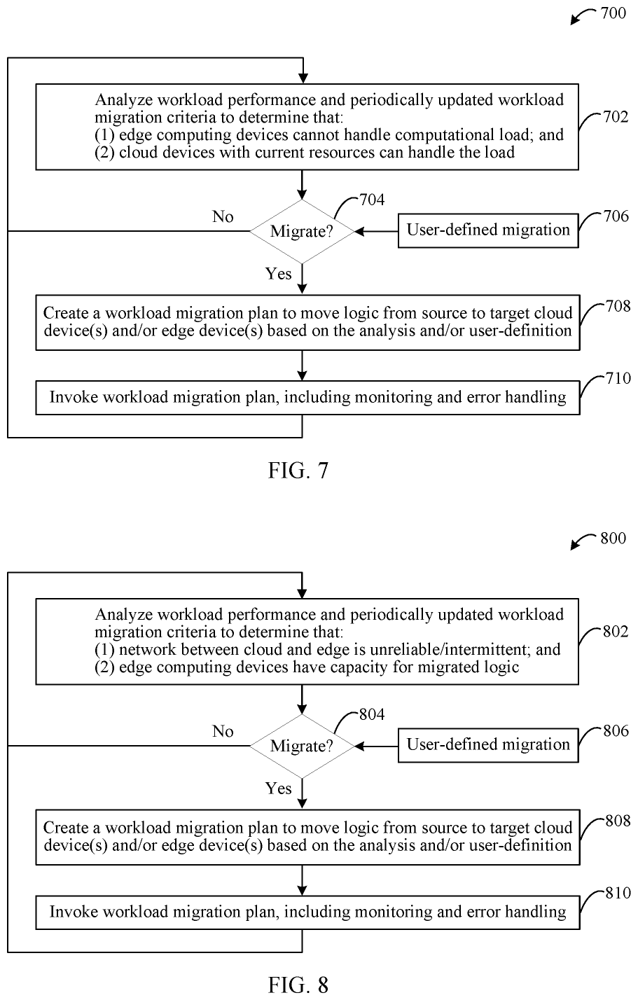

FIG. 7 is a flowchart of an example method for data streaming workload migration in accordance with an example embodiment.

FIG. 8 is a flowchart of an example method for data streaming workload migration in accordance with an example embodiment.

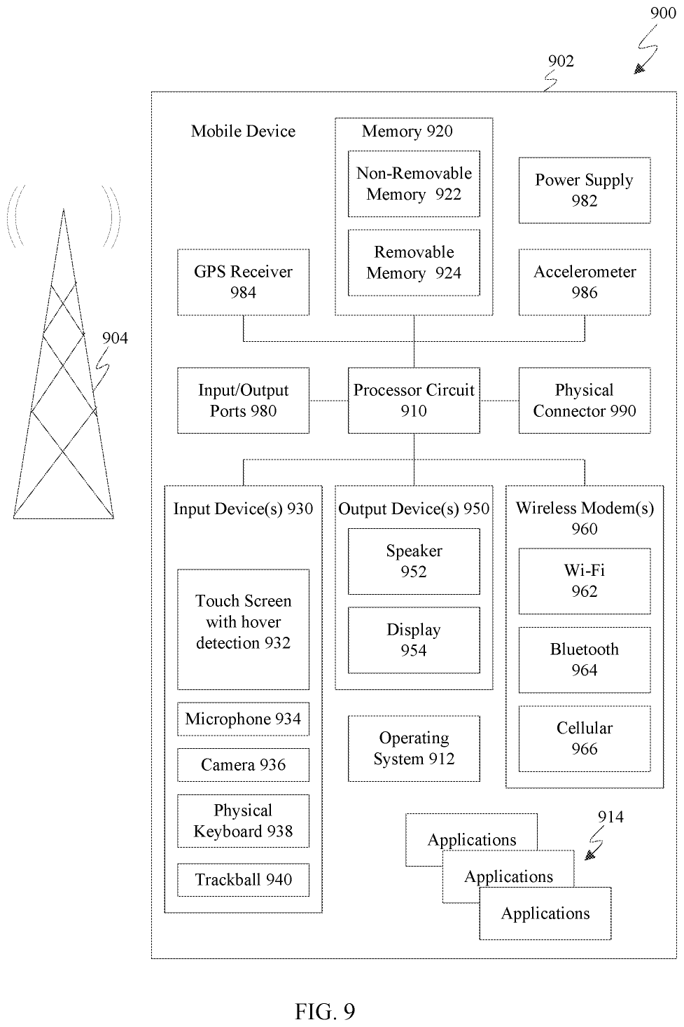

FIG. 9 shows a block diagram of an example mobile device that may be used to implement various example embodiments.

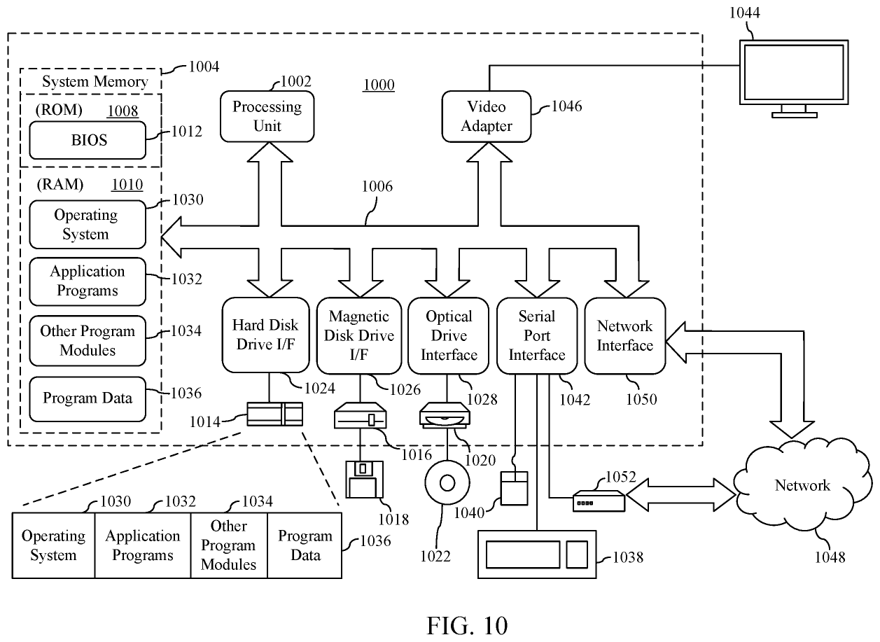

FIG. 10 shows a block diagram of an example computing device that may be used to implement embodiments.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose one or more embodiments that incorporate the features of the present invention. The scope of the present invention is not limited to the disclosed embodiments. The disclosed embodiments merely exemplify the present invention, and modified versions of the disclosed embodiments are also encompassed by the present invention. Embodiments of the present invention are defined by the claims appended hereto.

Each embodiment is presented as an example among many possible examples of the subject matter disclosed and/or claimed herein. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner

II. Example Embodiments for Automated Cloud-Edge Streaming Workload Distribution and Bidirectional Migration with Lossless, Once-Only Processing

Cloud computing costs may increase concomitant with resources utilized or reserved. Increased loading may lead to resource scale out and increased costs. Network communications may be unpredictably slow. Cloud and/or edge computing device loads may vary over time. Streaming data may comprise personally identifiable information (PII), which may be at greater risk of acquisition and misuse when communicated over public networks. Inflexible processing may waste resources, increase costs and/or delays. Flexible processing with workload migration may involve significant downtime, data losses and duplication. These and other problems may be addressed by automated cloud-edge streaming workload distribution and bidirectional migration with lossless, once-only data stream processing.

Automated cloud-edge streaming workload distribution and bidirectional migration with lossless, once-only data stream processing may, for example, reduce costs, reduce latency, reduce processing time, protect PII, reduce migration downtime, losses and duplication. For example, edge computing devices may be utilized alone or in conjunction with cloud computing devices to process streaming data. A cloud service may provide workload and bidirectional migration management between cloud and edge to provide once-only processing of data streams before and after migration. Migrated logic nodes may begin processing data streams where processing stopped at source logic nodes before migration without data loss or repetition, for example, by migrating and using anchors in pull-based stream processing. Query logic implementing customer queries of data streams may be distributed to edge and/or cloud devices based on placement criteria. Query logic may be migrated from source to target edge and/or cloud devices based on migration criteria.

A. Example System for Automated Cloud-Edge Streaming Workload Distribution and Bidirectional Migration with Lossless, Once-Only Processing

FIG. 1 is a block diagram of an example system for automated cloud-edge streaming workload distribution and bidirectional migration with lossless, once-only data stream processing in accordance with an example embodiment. Example system 100 is one of many possible example implementations. As shown in FIG. 1, example system 100 may comprise cloud service 102, storage 108, customer computing devices 128, IoT devices and applications 132, cloud gateway 134, edge computing devices 136 and cloud computing devices 138.

Cloud and edge devices may be communicatively coupled, for example, via one or more network(s), which may comprise any one or more communication links, some, but not all of which are shown by example in FIG. 1. In an example, network(s) may comprise one or more wired and/or wireless, public, private and/or hybrid networks, such as local area networks (LANs), wide area networks (WANs), enterprise networks, the Internet, etc. In an example, network(s) may comprise a dedicated communication link.

Example system 100 delineates cloud and edge. Cloud computing refers to third party computer system resources (e.g. data storage and computing). Cloud computing may comprise, for example, data centers available (or limited) to one or more customers (e.g. over the Internet). Clouds may be private, public or hybrid. In one of many examples, the edge may comprise the edge of the IoT, e.g., where a customer's network interfaces with the Internet. For example, cloud computing devices 138 may be dedicated to providing cloud services (e.g. to many customers who connect their computing devices to the Internet) while edge computing devices may be, for example, customer computing devices dedicated to customer operations. Devices such as cloud gateway 134 may provide an interface between cloud and edge.

A customer (e.g. with one or more users) may interact with a cloud, for example, using customer computing devices 128. Customer computing devices 128 may comprise, for example, endpoint devices (e.g. desktops, laptops, tablets, mobile phones) that users may operate to access and use a (e.g. corporate or cloud) server, e.g., via network (LAN, WAN, etc.). Users of customer computing devices 128 may represent, for example, a customer or tenant of cloud service 102. A tenant may comprise a group of one or more users (e.g. employees of customer) who have access to cloud service 102.

Customer computing devices 128 may be any type of stationary or mobile computing device, including a mobile computer or mobile computing device (e.g. Microsoft® Surface® device, laptop computer, notebook computer, tablet computer, such as an Apple iPad™, netbook), a wearable computing device (e.g. head-mounted device including smart glasses, such as Google® Glass™), or a stationary computing device, such as a desktop computer or PC (personal computer).

Customer computing devices 128 may (e.g. each) comprise a display, among other features, e.g., as presented by examples in FIGS. 9 and 10. Customer computing devices 128 may display a wide variety of interactive interfaces to a user, such as cloud service graphical user interface (GUI) 130. A user may access GUI 130, for example, by interacting with an application (e.g. Web browser application) executed by a customer computing device. A user may provide or select a network address (e.g. a uniform resource locator) for cloud service 102. Cloud service 102 may, for example, provide a login webpage (e.g. GUI 130) for a computing device to render on a display. A web service webpage (e.g. user interface 130) may be provided, e.g., following customer login, for a computing device to render on a display. A user may provide information (e.g. streaming data job, job placement and/or migration information, such as user-defined migration and/or parameters therefor) to cloud service 102, for example, by using cloud service GUI 130 to upload or otherwise transmit the information to cloud service 102, e.g., via one or more network connections (e.g. Internet). Cloud service 102 may receive, store and process information provided by a user through computing devices 128.

Users may interact with computing devices 128 to create or edit streaming data jobs and perform other tasks (e.g. monitor cloud service execution of jobs). Jobs may comprise any type of computer-executable instructions. A job may comprise a query pertaining to (e.g. inquiring about) information in one or more data streams. A query may be implemented (e.g. by cloud service 102), for example, with query logic (e.g. business logic) that operates on one or more data streams. Cloud service 102 may process streaming data jobs, including job placement and/or migration information, for example, as described below.

IoT devices/applications 132 may comprise, for example, data sources, which may stream data. A data source may be any source of data (e.g. sensor, computer devices, web sites, social media feeds, applications, and so on) that sources any type of data (e.g. streaming data). Streaming data may comprise data that can be analyzed in real-time or near real-time without storage or may be streamed from storage. An example of a source of streaming data may be, for example, a remote oil rig with thousands of sensors generating data for analyses, e.g., streamed out through one or more gateway devices (e.g. cloud gateway 134) to edge and/or cloud servers.

Devices such as cloud gateway 134 may provide an interface between cloud and edge. Cloud gateway 134 may be a gateway with cloud awareness or intelligence. Cloud gateway 134 may provide, for example, secure connectivity, event ingestion, bidirectional communication and device management. Cloud gateway 134 may provide a cloud hub for devices to connect (e.g. securely) to a cloud and send data. Cloud gateway 134 may comprise a hosted cloud service that ingests events from devices. Cloud gateway 134 may (e.g. also) provide device management capabilities (e.g. command and control of devices). Cloud Gateway 134 may act as a message broker between devices and backend services. Cloud gateway 134 may comprise, for example, Microsoft Azure® IoT Hub and/or Event Hub.

Cloud gateway 134 may support streaming data from IoT devices/applications 132 to cloud service 102 and/or other cloud components, such as edge computing devices 136 and cloud computing devices 138. IoT devices 132 may register with a cloud (e.g. via cloud gateway 134). IoT devices 132 may connect to a cloud, for example, to send and receive data. IoT devices may be, for example, IoT edge devices, which may run cloud intelligence themselves. IoT edge devices may perform some data processing themselves and/or in a field (e.g. customer) gateway (not shown).

As previously indicated, cloud computing devices 138 may be dedicated to providing cloud services (e.g. to many customers) while edge computing devices may be, for example, customer computing devices dedicated to customer operations. Cloud services are provided by cloud computing devices 138. Cloud computing devices 138 may be a considerable distance from a customer's IoT edge and may rely on one or more networks for communications (e.g. with IoT devices/applications 132). Cloud computing devices 138 may be at or near capacity at one or more times. Edge computing devices 136 may have some bandwidth available. Cloud computing devices 138 may (e.g. accordingly) be used by cloud service 102 to perform portions of a cloud computing workload, e.g., based on an evaluation of one or more criteria to place and/or migrate workloads. Cloud and edge computing devices 138, 136 may be available for placement and bidirectional migration of streaming data workloads. Other resources may be available as full or limited cloud resources, such as other computing or storage devices (e.g. SQL servers) in cloud or edge.

Cloud services, such as streaming data analytics, may be performed by edge devices (e.g. edge computing devices 136), for example, by running one or more components of a cloud service to provide edge devices with cloud intelligence (e.g. interoperability with one or more cloud services). In an example, a device may be turned into an IoT edge device (e.g. available as full or limited, such as customer-specific, cloud resources) by installing and executing an IoT edge runtime. In an example, an IoT Edge runtime may comprise one or more cloud programs (e.g. components or modules) that may be installed on a device to create an IoT Edge device. Components of IoT Edge runtime may enable IoT Edge devices to receive code (e.g. one or more portions of streaming data workload logic) to run at the edge and communicate (e.g. results). In an example, IoT Edge runtime may comprise an IoT Edge hub (e.g. for communication) and an IoT Edge agent (e.g. to deploy and monitor modules). IoT edge hub may act as a local proxy for IoT Hub.

One or more cloud services, e.g., cloud data stream analytics, may run on IoT edge devices. An example of data stream analytics is Microsoft Azure® Stream Analytics, although this example is not intended to be limiting. Stream analytics may provide, for example, an event processing engine, permitting analysis of data streams from applications and IoT devices, e.g., in real time. Cloud computing devices 138 and edge computing devices 136 may run data stream analytics, permitting cloud service 102 to place and migrate workloads according to criteria. Customers may be interested in moving parts of their data streaming workload from cloud devices to their edge devices, for example, to reduce costs, reduce time to insight on streaming data (e.g. by reducing the time devices spend sending messages to the cloud), avoid slow or disrupted communications and improve reaction time to changes in data.

Cloud service 102 may comprise any type(s) of cloud service, e.g., IaaS, PaaS, SaaS, BaaS, FaaS and so on. Cloud service 102 may be implemented by any number and type of computing devices. Cloud service 102 may comprise a private, public and/or hybrid cloud. Cloud service components are presented by way of non-limiting example. Components may be implemented on one or more computing devices. Component functionality may be merged or split in a variety of implementations.

Cloud service 102 may comprise a variety of components that are not shown for clarity. For example, cloud service 102 may comprise a front end server, an autoscaler, a resource allocator, a scheduler service and so on. These components are briefly described.

A front end server may provide, for example, cloud service GUI 130 and application programming interfaces (APIs) for customer service requests, manage data and/or computing resources, etc. In an example, a front end server may provide cloud service GUI 130 to customer computing devices 128 to present to users on a display. A front end server may receive, for example, customer streaming data jobs, placement and migration criteria (e.g. policies specifying constraints), user-defined migration, performance requirements (e.g. in service level agreements (SLAs)) and so on. A front end server may communicate with storage (e.g. storage 108), for example, to store criteria 126. A front end server may communicate with various cloud service modules, such as workload placement manager 104, for example, to provide streaming data jobs, placement and migration criteria and so on. A front end server may communicate with a scheduler service, for example, to schedule execution of streaming data jobs. A front end server may communicate with an autoscaler, for example, to provide autoscaling policies specified by a customer.

An autoscaler may, for example, automatically adjust the capacity of one or more data and/or computing resources for a tenant's computing tasks. An autoscaler may increase (scale out) or decrease (scale in) the capacities of one or more resources in response to varying loads placed on the one or more resources. Autoscaling may be implemented, for example, to comply with performance levels specified in a tenant's SLA. An autoscaler may communicate with a scheduler service and a resource metrics service, for example, to receive and analyze current and prospective loading to make scaling decisions. An autoscaler may communicate with a resource allocator, for example, to allocate resources in accordance with autoscaling policies.

A resource allocator may allocate resources. A resource allocator may scale out or scale in resources, for example, by increasing or decreasing the number of instances of one or more resources. A resource allocator may communicate with an autoscaler and resources, for example, to carry out resource scaling directed by an autoscaler.

Resources may comprise physical and/or virtual resources. Resources may include, for example, computer networks, servers, routers, storage, applications, services, virtual machines, containers, etc. Physical resources may be centralized (e.g. clustered) and/or distributed. In an example, one or more resource clusters may be co-located (e.g. housed in one or more nearby buildings with associated components, such as backup power supplies, redundant data communications, environmental controls, etc.) to form a datacenter. Resources may comprise one or more datacenters. In an example, resources may comprise cloud computing devices 138. Edge computing devices 136 may comprise, for example, customer-specific resources.

A resource monitor may generate, collect and/or store information about instantiated resources (e.g. resource log and metrics). A resource monitor may communicate with a resource metrics service, for example, to provide monitored resource metrics for storage and/or analyses. In an example, a resource monitor may utilize agents associated with resources to monitor and/or collect resource information. A (e.g. each) resource instance may have, for example, an associated agent application that generates resource information (e.g. metric and/or log data) for the associated resource. Resource information may be stored, for example in storage 108. Resource information involved in workload placement and/or migration analyses may be stored, for example, as criteria 126.

A scheduler service (e.g. Microsoft Azure® Scheduler) may schedule streaming data jobs for execution utilizing one or more resources. A scheduler service may communicate with a front end server, for example, to receive scheduling information received by a front end server. A scheduler service may communicate with resources (e.g. resource instances), for example, to schedule service.

Storage 102 may comprise any number of storage devices (e.g. in one or more locations) and any type of storage that stores any type of information. Storage is discussed in greater detail, for example, with respect to FIGS. 9 and 10. The example in FIG. 1 shows several examples of information that may be stored, although many other types of information may be stored. Storage 102 may communicate, for example, with cloud service 102, cloud computing devices 138, edge computing devices 136, cloud gateway 134 and so on.

Data collector 122 may be configured, for example, to collect, store and provide access to information of interest to workload placement manager 104 and workload migration manager 106, such as workload performance statistics 127, criteria 126 (e.g., placement and migration criteria) and checkpoints 124 (e.g. blob storage of checkpoints used in migration).

Cloud service 102 may provide, among other cloud services, data stream processing services. An example of data stream processing service is Microsoft Azure® Stream Analytics, although this example is not intended to be limiting. A stream analytics service may provide an event-processing engine to process/examine data streaming from one or more devices. Incoming data may be from devices, sensors, web sites, social media feeds, applications, etc. Information may be extracted from data streams, e.g., to identify patterns and relationships. Patterns may be used, for example, to trigger other actions downstream, such as to create alerts, feed information to a reporting tool and/or store information. Examples of data stream analytics include IoT sensor fusion and real-time analytics on device telemetry, web logs and clickstream analytics, geospatial analytics for fleet management and driverless vehicles, remote monitoring and predictive maintenance of high-value assets, real-time analytics on Point of Sale data for inventory control and anomaly detection, etc.

A source of streaming data may comprise data ingested into, for example, Azure®

Event Hub, Azure® IoT Hub or from a data store, such as Azure® Blob Storage (e.g. storage 108). Streams may be processed/examined, for example, based on a stream analytics job. A stream analytics job may be configured with an input, an output, and a query to run on the data. A job may specify, for example, an input source that streams data, a transformation query that identifies (e.g. defines how to look for) data, patterns, or relationships. A transformation query may, for example, use an SQL query language, e.g., to filter, sort, aggregate, and join streaming data over a period of time. Event ordering options and a duration of time windows may be adjustable, e.g., during job execution when performing aggregation operations. An output may be specified for transformed data. Actions may be taken, such as sending data to a monitored queue to trigger alerts or custom workflows downstream, sending data to a dashboard for real-time visualization, storing data (e.g. for batch analytics or to develop a machine learning model based on historical data), etc. A stream analytics pipeline may refer to how input data is provided to stream analytics, analyzed and/or transformed and forwarded for other actions (e.g. storage or presentation).

In an example, an industrial automation customer may have an automated manufacturing process with hundreds or thousands of sensors (e.g. IoT devices 132) capable of emitting streams of data in real time. A field gateway may push data streams to a cloud device (e.g. cloud gateway 134). Real-time insights from sensor data may indicate patterns and potential actions to take. Stream Analytics Query Language (SAQL) may be used to create one or more queries to search (e.g. analyze) a stream of sensor data to find desired information. A stream analytics job (e.g. implementing one or more queries) may ingest events from a cloud gateway and run real-time analytics queries against the streams. Query results may be provided to one or more outputs. Queries may, for example, archive raw data (e.g. pass through input to output without analysis), filter data (e.g. based on a condition) to reduce data analyzed, monitor data (e.g. based on time windows) to trigger alerts, displays or other business logic, detect the absence of one or more events, etc.

Cloud service 102 may provide workload placement and migration services for streaming data jobs provided, for example, via customer computing devices 128. Cloud service 102 may comprise, for example, workload placement manager 104 and workload migration manager 106. Other implementations may comprise other components to provide data stream workload placement and migration.

Workload placement manager 104 may receive a query pertaining to at least one data stream. For example, workload placement manager may receive a stream analytics job indicating one or more queries about one or more input streams and one or more outputs. Workload placement manager 104 may process the job, for example, by determining query logic for queries and subqueries, determining where to place query logic, configuring, instantiating and starting query logic.

Workload placement manager 104 may determine query logic to implement the query relative to specified data streams. For example, workload placement manager 104 may determine query and subquery logic that would implement a query. Query logic may create a workload on one or more resources (e.g. computing devices, storage devices) that implement the logic. Expected loading caused by query logic may be based on, for example, logic complexity, resource consumption, data volume, compute time, interconnectivity, communication time, storage time, number and type of computations, number of outputs, etc. involved to accomplish the query.

Workload placement manager 104 may comprise, for example, placement criteria analyzer 110, placement planner 112 and placement implementer 114.

Placement criteria analyzer 110 may analyze the workload created by the logic and workload placement criteria (e.g. statistical data, rules), for example, to determine workload placement/distribution on cloud and/or edge resources. Placement criteria analyzer 110 may access workload placement criteria, for example, in criteria 126 stored in storage 108. Criteria 126 may be periodically updated. Workload placement criteria considered in an analysis may comprise, for example, edge and cloud communication quality, latency, edge load or capacity for additional workloads, cloud load or capacity for additional workloads, a workload performance requirement (e.g. for the customer and/or the query), cost of cloud workload deployment, system constraints, customer constraints (e.g. PII handling, maximum cost), GDPR, compliance issues, amount and type of data, country of origin constraints or restrictions, etc.

Placement planner 112 may (e.g. based on the analysis) create a workload placement plan to deploy the query logic. Placement planner 112 may select between an edge deployment, a cloud deployment and a split/hybrid deployment on cloud and edge. Results of the analysis of the workload and workload placement criteria may determine the deployment. In an example, edge and/or cloud computing devices 136, 138 may not be part of a deployment, for example, when they lack capacity for additional workload. In an additional example, participation of cloud computing devices 138 may be limited, for example, when streaming data comprises PII and there is a customer constraint about PII handling by cloud service 102. In an example, a workload placement plan may split deployment of query logic between the cloud and edge, restricting processing of PII to the edge based on workload placement criteria comprising a customer constraint for PII handling. In another example, a workload may be implemented, at least in part, on edge computing devices, for example, to satisfy customer cost constraints and/or to avoid faulty communications with the cloud.

Placement implementer 114 may invoke or execute a workload placement plan to create a deployed workload that provides stream processing of the at least one data stream based on the query logic. Placement implementer 114 may follow a workload placement plan, for example, by creating instances of query logic on computing devices specified in the plan, connecting the instances of query logic, initializing the states of the logic instances, and starting the logic instances. Logic nodes may comprise, for example, an input node, a compute node and an output node. A node may comprise a query processing unit. A node may comprise a logical entity without physical constraint. A compute node may perform a query or subquery workload. Nodes may process one or more data streams based on query logic. Logic may be implemented as a plurality of interconnected processes and/or subprocesses. Logic may be implemented, for example, as parallel processes. Processes may comprise, for example, software logic performing tasks and communicating with each other. Processes may be mobile without regard to physical environment. Processes may be implemented with significant flexibility, e.g., one node per process or any other arrangement/configuration. In an example, e.g., as shown in FIG. 2A, placement implementer 114 may instantiate query logic on edge and/or cloud computing devices 136, 138 in accordance with a workload placement plan.

FIG. 2A is a block diagram of example data streaming workload placement in accordance with an example embodiment. FIG. 2A presents one of an endless number of possible workload placement examples. FIG. 2A shows an example of a split/hybrid deployment of a workload plan. Connectivity is not shown for clarity. In this example, the workload plan is implemented with four pipelines. Edge computing devices 202 may be examples of edge computing devices 136 with an assigned workload on one or more edge computing devices. Cloud computing devices 204 may be examples of edge computing devices 138 with an assigned workload on one or more cloud computing devices. Edge computing device A 202A comprises, as an example, two (first and second) parallel pipelines 206, 208. First pipeline 206 comprises input node 1, compute node 1 and output node 1. Second pipeline 208 comprises input node 2, compute node 2 and output node 2. Cloud computing device A 204A comprises, as an example, two (third and fourth) parallel pipelines 210, 212. Third pipeline 210 comprises input node 3, compute node 3 and output node 3. Fourth pipeline 212 comprises input node 4, compute node 4 and output node 4.

Stream processing (e.g. implemented by query logic) may be implemented, for example, using anchor-based stream processing. In particular, stream processing may be performed using a pull-based, anchor-based methodology for once-only processing. A (e.g. each) node (e.g. computing device) in a graph (e.g. representing interconnected computing devices) may establish a system of anchors. An anchor may describe a point in an output stream of a node, such that every event in a stream is either before or after any given anchor.

An anchor may represent a (e.g. physical) point in a data stream. An anchor may be a list of anchors. A time associated with an anchor may represent a logically-meaningful time value associated with data in a data stream. Data in a data stream may be, but is not limited to, event data. In an example, an anchor (A) may be used to partition a stream of data into two portions: the data or events (E) that came before the anchor, and the data or events that came after the anchor. Any unit of data or event may be compared to any anchor, for example, even though units of data or events themselves may not be compared to other data. Anchors may be used to read data from streams. Time may be used to initiate operations to generate requested results.

Downstream nodes may use the anchors of upstream nodes to pull data. An anchor supplied by a down-stream node after a restart may tell a down-stream node precisely which events the down-stream node has not yet processed. A down-stream node may read its own state upon recovery and resume pulling data from an up-stream node using its last-used anchor. Coordination between nodes may be unnecessary in checkpointing and recovery. Recovery, e.g., in the context of streaming computation, may encompass failure of a node performing a streaming computation being restarted and resuming its computations from the point at which it failed.

In an example, an anchor may have two parts, a transient description of a current point that may be used to optimize normal processing and a durable description of the same point that may be used in the event of a restart. Anchors of input streams may correspond to one or more (e.g. a combination of) physical aspects of a stream. Examples of physical aspects of a stream include, but are not limited to, an offset, an arrival time, or a file identifier. Anchors of computing nodes may comprise the anchors of their inputs. Data that precedes an anchor may be data that would be output if the events that precede the input anchors were ingested and all possible processing were performed on them. A wide variety of failures (e.g. crash, outage) may be recovered from, including, for example, when multiple failures may cause a system to execute along incompatible paths.

A computing device implementing all or a portion of query logic may comprise, for example, one or more of (e.g. any combination of any number of the following): an input node, a computing node, and an output node. An input node may read or access data from one or more data sources and may generate input for a compute node. A compute node may perform computations on data. A compute node may be an input node for another compute node. A compute node may generate new data streams. An output node may write data from a compute node to a data sink (e.g. to storage).

Stream processing may be based on anchors, where an anchor (e.g. an input anchor) may represent a point in a data stream. Anchors may be used to read data from data streams. An anchor (e.g. a compute node anchor) may be a list of anchors. An anchor may be a list of a list of anchors to any level of nesting. Anchors may be created by an input node. Anchors may be created by a compute node. Anchors created by a compute node may be a list of input anchors. Output nodes may receive anchors and store them. Stream processing may be based on time, where time may represent a logically-meaningful time value associated with a unit of data, such as, but not limited to, an event. Time may be used to initiate processing to return requested results. In an example, an anchor may be used to partition a data stream into two portions (e.g. events before and after the anchor, for example, when the data stream comprises a stream of events.

Data streams may be processed using anchors to achieve once-only processing and once-only output, meaning that no output is lost and that no output is generated twice, for example, even when recovery (or migration) may be performed. An anchor may enable any receiver of data to know which data has been processed (e.g. data before the anchor) and which data has not been processed (e.g. data after the anchor).

A computing device that processes an output stream (e.g. an output node) may set and store a current anchor (e.g. last anchor generated), for example, so that when a request to continue is received, the computing device may use the current anchor into the output stream to access unsent results from output data streams, e.g., rather than resending data. This may support once-only processing and output. A node writing output (e.g. an output node) may control what data is sent to it using anchors. Physical anchors may be used for input data streams. Physical anchors may be physical aspects of an input data stream, such as, but not limited to, an offset into a file. An offset into a file may indicate how many bytes of a file have already been read and/or processed. This information, while it may not be logically meaningful information, may enable an input node to resume stream processing from the exact place at which it left off.

An anchor comprising a list of anchors of input data streams may be used by a node processing input data streams (e.g. a compute node) to generate an anchor for the output of the computing node. This may enable a compute node to know where to start processing in an input data stream or streams. A relationship may exist between the anchors and a point in time associated with the data for which output may be requested. This may enable a requester to make a request, such as: “start generating output at 2 pm.”

Anchor-based stream processing may also be carried out as follows. During a startup phase: start anchor request(s), each identifying a particular time, may be accumulated until request(s) are pending from downstream nodes. A minimum time of the accumulated start anchor request(s) may be determined. An anchor associated with a determined minimum time may be generated, for example, when a processing system is an input node. A start anchor request may (e.g. otherwise) be provided to an upstream node identifying a determined minimum time. An anchor may be provided in response to a polled start anchor request anchor for a determined minimum from a downstream node, for example, when an anchor associated with a determined minimum time may be (e.g. is) received (or generated). Asynchronous requests for batches of data bounded by two specific anchors may be performed in accordance with information stored in an ordered collection of anchors during a recovery phase.

Returning now to the description of FIG. 1, workload migration manager 106 may determine when and how to migrate all or a portion of a deployed workload. Workload migration manager 106 may utilize access to information about the deployed workload to monitor its progress and performance statistics. Workload migration manager 106 may comprise, for example, migration criteria analyzer 116, migration planner 118 and migration implementer 120.

Migration criteria analyzer 116 may monitor a deployed workload, for example, by analyzing workload performance statistics 127 for the deployed workload and workload migration criteria 126 to determine whether and how to migrate at least a portion of the deployed workload to/from cloud and/or edge resources. A determination may be made according to one or more algorithms, which may weight variables according to importance. Algorithms may vary widely according to cloud and edge implementations and objectives, etc.

Migration criteria analyzer 116 may access workload performance statistics 127 and workload placement criteria (e.g. criteria 126) stored in storage 108. Criteria 126 and workload performance statistics 127 may be periodically updated, for example, by data collector 122. Migration criteria analyzer 116 may consider, for example, whether improvements may be made to stream processing performance, such as efficiency, cost-effectiveness, etc. Cloud and edge conditions may vary between assessments. In an example, additional edge computing devices 202 may have become available and/or computing devices with improved (e.g. faster, higher quality) communications may have become available after workload placement. Workload migration criteria considered in an analysis may comprise, for example, edge and cloud communication quality, latency, edge load or capacity for additional workloads, cloud load or capacity for additional workloads, a workload performance requirement (e.g. for the customer and/or the query), cost of cloud migration, cost savings from migration, system constraints, customer constraints (e.g. PII handling, maximum cost), GDPR, compliance issues, amount and type of data, country of origin constraints or restrictions, time since placement, time since the last migration, etc. Workload migration manager 106 may also consider, for example, customer-defined migration. In an example, a customer may force migration regardless of performance or criteria.

Migration planner 118 may (e.g. based on the analysis) create a workload migration plan to migrate deployed query logic. Migration planner 118 may select between an edge deployment, a cloud deployment and a split/hybrid deployment on cloud and edge. Migration may migrate all or a portion of logic from cloud to edge or vice versa. Depending on workload placement, migration may migrate one or more portions of workload logic edge to edge, edge to cloud, edge to edge and cloud, cloud to cloud, cloud to edge, and/or cloud to cloud and edge. A migration plan may, for example, specify existing (source) query or subquery logic on one or more source computing devices to migrate to one or more target computing devices.

Migration implementer 120 may invoke or execute a workload migration plan to create a migrate all or a portion of a deployed workload that continues to provide stream processing of the at least one data stream based on the query logic. Migration implementer 120 may determine logic nodes affected by the migration plan. Migration implementer 120 may invoke a workload placement plan, for example, by stopping the one or more source query logic nodes affected by the workload migration plan, checkpointing the stopped source query logic node to create a snapshot of a state of the at one or more source query logic nodes, creating one or more target query logic nodes (e.g. instances of query logic nodes) with a configuration and connections matching a configuration and connections (e.g. graph topology) of the at least one source query logic node; providing the one or more target query logic nodes with the state of the one or more source query nodes from the checkpoint; and starting the one or more target query logic nodes.

Data may stop flowing to/from stopped logic nodes, but may continue for unaffected logic nodes. No more data may be pulled from source entities using anchors.

A checkpoint of stopped logic node(s) may, for example, comprise any identifier or other reference that identifies a state of data at a point in time. A checkpoint may differ from an anchor, for example, in that an anchor identifies a point in a data stream. An anchor may not include a state of data. A checkpoint may be stored, for example, as a binary large object (BLOB). For example checkpoints 124 may be stored in storage 108, e.g., for access by a migration target computing device to replicate the state of source logic nodes in target logic nodes instantiated and connected on a target computing device.

Migration may use an anchor protocol, for example, in support of (e.g. to ensure) once-only processing of streaming data, once-only data output and that no data is lost (e.g. lossless data processing). An anchor of a last batch of data generated by a source logic node or entity in a source runtime being migrated may be assigned as start node of the same (target) entity in a target runtime. Input determined based on an anchor, for example, rather than a timestamp, may ensure an input is read only once. A timestamp may comprise, for example, a sequence of characters or encoded information that may identify when an event occurred or is recorded by a computer. The anchor recorded may be the last one, which may ensure no data is emitted from a migrated entity after the anchor is recorded. Checkpointing after logic nodes are stopped and an anchor is recorded (e.g. with the anchor as a checkpoint key) may help ensure that no input is reprocessed.

A checkpoint may contain source data and anchor states. Checkpointed anchors from source output nodes may be assigned to target output nodes on a target computing device. A target output node/entity may be configured, for example, with the source output node anchor. An output node anchor may be used to tell an output node where in data to start processing or pulling data from an upstream node, e.g., to avoid reprocessing. Compute nodes and data nodes may have their states preserved in a checkpoint. Any data in the checkpoint blob from the source entities is provided to the target entities.

State restoration may occur, for example, by providing a target output node with a source output node anchor. When the target output node passes the anchor to an upstream entity, upstream entities may fetch a checkpoint (e.g. in a stored BLOB) to restore state, for example, in response to the target output node passing its assigned anchor to the upstream entity.

Components may be started independently of each other, which may minimize latency and downtime. Output nodes have anchors to pull data from upstream nodes while input nodes (if migrated) may initiate connections to data source(s).

Anchors may be used to support lossless, once-only processing and output before and after migration stream processing. A target output node begins by pulling data from an upstream node that was not pulled by the source output node from an upstream node, which provides once-only, lossless processing of the at least one data stream before and after migration.

In an example, e.g., as shown in FIG. 2B, migration implementer 120 may migrate query logic on edge and/or cloud computing devices 136, 138 in accordance with a workload migration plan.

FIG. 2B is a block diagram of example data streaming workload migration in accordance with an example embodiment. FIG. 2B presents one of an endless number of possible workload migration examples. Depending on workload placement, migration may migrate one or more portions of workload logic edge to edge, edge to cloud, edge to edge and cloud, cloud to cloud, cloud to edge, and/or cloud to cloud and edge. FIG. 2B shows an example of bidirectional migration of portions of a workload plan (e.g. shown in FIG. 2A). Interconnectivity of logic is not shown for clarity. In this example, migration is implemented by keeping four pipelines intact while migrating three of them between cloud and edge computing devices. In this example (e.g. comparing workload placement in FIG. 2A to workload migration in FIG. 2B), first pipeline 206 remains on edge computing device A 202A, second pipeline 208 migrates from edge computing device A 202A to cloud computing device C 204C (where it is represented as second pipeline 208m), third pipeline 210 migrates from cloud computing device A 204A to cloud computing device B 204B (where it is represented as third pipeline 210m) and fourth pipeline 212 migrates from cloud computing device A 204A to edge computing device B 202B (where it is represented as fourth pipeline 212m). As previously indicated, while the example shows pipelines being migrated, migration may move any portion of logic or all logic.

B. Example Methods for Automated Cloud-Edge Streaming Workload Distribution and Bidirectional Migration with Lossless, Once-Only Processing

Embodiments may also be implemented in processes or methods. For example, FIG. 3 is a flowchart of an example method for data streaming workload placement in accordance with an example embodiment. Embodiments disclosed herein and other embodiments may operate in accordance with method 300. Method 300 comprises steps 302 to 310. However, other embodiments may operate according to other methods. Other structural and operational embodiments will be apparent to persons skilled in the relevant art(s) based on the foregoing discussion of embodiments. No order of steps is required unless expressly indicated or inherently required. There is no requirement that a method embodiment implement all of the steps illustrated in FIG. 3. FIG. 3 is simply one of many possible embodiments. Embodiments may implement fewer, more or different steps.

Method 300 begins with step 302. In step 302, a query may be received pertaining to at least one data stream. For example, as shown in FIG. 1, cloud service 102 (e.g. a front-end server) may receive a streaming workload job comprising a query from a customer computing device among customer computing devices 128. The query may be provided to workload placement manager 104.

At step 304, a workload (e.g. query logic) to process the query may be determined. For example, as shown in FIG. 1, workload placement manager 104 may determine query logic to implement a received query.

At step 306, the workload and periodically updated workload placement criteria may be analyzed. For example, as shown in FIG. 1, placement criteria analyzer 110 may analyze the workload and workload placement criteria obtained by data collector 122 and stored in storage 108.

At step 308, a workload placement plan on cloud device(s) and/or edge device(s) is created based on the analysis of the workload and workload placement criteria. For example, as shown in FIG. 1, placement planner 112 creates a workload placement plan based on the analysis by placement criteria analyzer 110.

At step 310, a workload placement plan is invoked. For example, as shown in FIGS. 1 and 2A, placement implementer 114 implements the placement plan created by placement planner 112 by instantiating, configuring and starting query logic (first-fourth pipelines 206, 208, 210, 212) on edge computing device 202A and cloud computing device 204A.

FIG. 4 is a flowchart of an example method for data streaming workload placement in accordance with an example embodiment. Embodiments disclosed herein and other embodiments may operate in accordance with method 400. Method 400 comprises steps 402 to 410. However, other embodiments may operate according to other methods. Other structural and operational embodiments will be apparent to persons skilled in the relevant art(s) based on the foregoing discussion of embodiments. No order of steps is required unless expressly indicated or inherently required. There is no requirement that a method embodiment implement all of the steps illustrated in FIG. 4. FIG. 4 is simply one of many possible embodiments. Embodiments may implement fewer, more or different steps.

Method 400 begins with step 402. In step 402, a query is analyzed subject to customer constraints and resource constraints. For example, as shown in FIG. 1, placement criteria analyzer 110 may analyze the query (e.g. query complexity) and workload placement criteria comprising customer constraints and resource constraints obtained by data collector 122 and stored in storage 108.

At step 404, a determination may be made that query seeks to analyze personally identifiable information (PII). For example, as shown in FIG. 1, placement criteria analyzer 110 may observe that the query seeks to analyze PII, which may restrict query placement.

At step 406, a determination may be made that there is a customer constraint restricting PII handling. For example, as shown in FIG. 1, placement criteria analyzer 110 may observe that criteria 126 includes a customer constraint that restricts PII handling, which may restrict query placement.

At step 408, a workload plan is created that splits query logic deployment so that PII is analyzed on edge device(s) and PII sent to cloud device(s) is anonymized For example, as shown in FIG. 1, placement planner 112 may create a workload plan that splits query logic deployment so that PII is analyzed on edge device(s) 202 and PII sent to cloud device(s) 204 is anonymized

At step 410, the privacy-preserving hybrid query logic plan is deployed to cloud and edge devices. For example, as shown in FIGS. 1 and 2A, placement implementer 114 implements the placement plan created by placement planner 112 by instantiating, configuring and starting a first portion of query logic (first and second pipelines 206, 208) on edge computing device 202A to analyze PII in the at least one data stream and anonymize PII provided to a second portion of query logic (second and third pipelines 210, 212) on cloud computing device 204A.

FIG. 5 is a flowchart of an example method for data streaming workload migration in accordance with an example embodiment. Embodiments disclosed herein and other embodiments may operate in accordance with method 500. Method 500 comprises steps 502 to 510. However, other embodiments may operate according to other methods. Other structural and operational embodiments will be apparent to persons skilled in the relevant art(s) based on the foregoing discussion of embodiments. No order of steps is required unless expressly indicated or inherently required. There is no requirement that a method embodiment implement all of the steps illustrated in FIG. 5. FIG. 5 is simply one of many possible embodiments. Embodiments may implement fewer, more or different steps.

Method 500 begins with step 502. In step 502, workload performance and periodically updated workload migration criteria are analyzed. For example, as shown in FIG. 1, migration criteria analyzer 116 analyzes workload performance statistics 127 and criteria 126 periodically collected by data collector 122 and stored in storage 108.

At steps 504 and 506, a determination is made whether to migrate any part of a deployed workload based on: (1) the analysis at step 502 or (2) user defined migration 506. For example, as shown in FIG. 1, migration criteria analyzer 116 determines whether to migrate any part of a deployed workload based on the analysis or based on user-defined migration provided by a customer computing device among customer computing devices 128. The procedure returns to step 502, for example, when migration criteria analyzer 116 determines that logic should not be migrated because performance statistics are satisfactory, migration criteria are not met and because there is no user-defined migration or, if there is, conditions don't meet user-defined migration. The procedure proceeds to migration planning step 508, for example, when criteria analyzer 116 determines that logic should be migrated because performance statistics are unsatisfactory, migration criteria are met, or because user-defined migration conditions are met.

At step 508, a workload migration plan is created to move at least a portion of logic from source to target cloud device(s) and/or edge device(s) based on the analysis and/or user-defined migration. For example, as shown in FIG. 1, migration planner 118 creates a workload migration plan to move at least a portion of deployed logic based on the analysis and/or user-defined migration.

At step 510, a workload migration plan, including monitoring and error handling, is invoked. For example, as shown in FIGS. 1 and 2B, migration implementer 120 implements the migration plan created by migration planner 118 by stopping logic to be migrated (source logic) on one or more source computing devices, instantiating, configuring and starting migrated query logic (target logic) on one or more target computing devices. Migration implementer 120 may determine logic nodes affected by the migration plan, stop the one or more source query logic nodes affected by the workload migration plan, checkpoint the stopped source query logic node to create a snapshot of a state of the at one or more source query logic nodes, create one or more target query logic nodes (e.g. instances of query logic nodes) with a configuration and connections matching a configuration and connections (e.g. graph topology) of the at least one source query logic node; provide the one or more target query logic nodes with the state of the one or more source query nodes from the checkpoint; and start the one or more target query logic nodes. As shown by example in FIG. 2, migration implementer 120 invokes migration by keeping four pipelines intact while migrating three of them between cloud and edge computing devices. In this example (e.g. comparing workload placement in FIG. 2A to workload migration in FIG. 2B), first pipeline 206 remains on edge computing device A 202A, second pipeline 208 migrates from edge computing device A 202A to cloud computing device C 204C (where it is represented as second pipeline 208m), third pipeline 210 migrates from cloud computing device A 204A to cloud computing device B 204B (where it is represented as third pipeline 210m) and fourth pipeline 212 migrates from cloud computing device A 204A to edge computing device B 202B (where it is represented as fourth pipeline 212m). Error handling for migration may comprise, for example, attempting one or more retries to overcome a failure, up to a maximum number of retries or timeout. A successful retry may, for example, result in continuing migration or, if migration is complete, returning to migration criteria analysis. An unsuccessful retry may, for example, result in a rollback to pre-migration status (e.g. restarting stopped logic) and returning to migration analysis.

FIG. 6 is a flowchart of an example method for data streaming workload migration in accordance with an example embodiment. Embodiments disclosed herein and other embodiments may operate in accordance with method 600. Method 600 comprises steps 602 to 610. However, other embodiments may operate according to other methods. Other structural and operational embodiments will be apparent to persons skilled in the relevant art(s) based on the foregoing discussion of embodiments. No order of steps is required unless expressly indicated or inherently required. There is no requirement that a method embodiment implement all of the steps illustrated in FIG. 6. FIG. 6 is simply one of many possible embodiments. Embodiments may implement fewer, more or different steps.

Method 600 begins with step 602. In step 602, workload logic entities affected by migration plan may be stopped. For example, as shown in FIGS. 1, 2A and 2B, migration implementer 120 may stop second pipeline 208, third pipeline 210 and fourth pipeline 212.

At step 604, a snapshot of the workload logic state, including anchors, is created in a checkpoint and stored as a blob. For example, as shown in FIGS. 1, 2A and 2B, migration implementer 120 may checkpoint second, third and fourth pipelines 208, 210, 212 and store the checkpoint as a blob in checkpoints 124 in storage 108.

At step 606, workload logic entities are migrated from migration source to migration target in the same configuration with the same connections. For example, as shown in FIGS. 1, 2A and 2B, migration implementer 120 instantiates and connects second, third and fourth pipelines 208m, 210m, 212m on migration targets cloud computing device C 204C, cloud computing device B 204B and edge computing device B 202B, respectively, in the same configuration and connections as second, third and fourth pipelines 208, 210 and 212 on migration sources edge computing device A 202A and cloud computing device A 204A, respectively.

At step 608, the state of migrated workload logic entities using blob is restored, including assigning anchor to output node. For example, as shown in FIGS. 1 and 2B, migration implementer 120 may utilize the checkpoint in checkpoints 124 to restore the states of logic nodes in migrated second, third and fourth pipelines 208m, 21m0, 212m, including assigning checkpointed anchors to target output node 2, target output node 3 and target output node 4.

At step 610, the migrated workload logic entities may be started. For example, as shown in FIGS. 1 and 2B, logic nodes in migrated second, third and fourth pipelines 208m, 210m, 212m may start independently, from where logic nodes left off before migration, with input node 2, input node 3 and input node 4 connecting to data streaming sources and output node 2, output node 3 and output node 4 providing their assigned anchors, respectively, to upstream nodes compute node 2, compute node 3 and compute node 4.

FIG. 7 is a flowchart of an example method for data streaming workload migration in accordance with an example embodiment. Embodiments disclosed herein and other embodiments may operate in accordance with method 700. Method 700 comprises steps 702 to 710. However, other embodiments may operate according to other methods. Other structural and operational embodiments will be apparent to persons skilled in the relevant art(s) based on the foregoing discussion of embodiments. No order of steps is required unless expressly indicated or inherently required. There is no requirement that a method embodiment implement all of the steps illustrated in FIG. 7. FIG. 7 is simply one of many possible embodiments. Embodiments may implement fewer, more or different steps.

Method 700 begins with step 702. In step 702, workload performance and periodically updated workload migration criteria are analyzed to determine that: (1) edge computing devices cannot handle computational load; and (2) cloud devices with current resources can handle the load. For example, as shown in FIG. 1, migration criteria analyzer 116 analyzes workload performance statistics 127 and criteria 126 periodically collected by data collector 122 and stored in storage 108 to determine that: (1) edge computing devices cannot handle computational load; and (2) cloud devices with current resources can handle the load.

At steps 704 and 706, a determination is made whether to migrate any part of a deployed workload based on: (1) the analysis at step 702 or (2) user defined migration 706. For example, as shown in FIG. 1, migration criteria analyzer 116 determines whether to migrate any part of a deployed workload based on the analysis or based on user-defined migration provided by a customer computing device among customer computing devices 128. The procedure proceeds to migration planning step 708, for example, based on criteria analyzer 116 determining that logic should be migrated because (1) edge computing devices cannot handle computational load; and (2) cloud devices with current resources can handle the load.

At step 708, a workload migration plan is created to move at least a portion of logic from source to target cloud device(s) and/or edge device(s) based on the analysis and/or user-defined migration. For example, as shown in FIG. 1, migration planner 118 creates a workload migration plan to move at least a portion of deployed logic based on the analysis and/or user-defined migration. With reference to the example shown in FIG. 2A, given that the analysis determined that edge computing devices 204 cannot handle the computational load, the migration plan would plan to migrate first and second pipelines 206, 208 to one or more cloud computing devices 204 and, if necessary, migrate third and fourth pipelines 210, 212 from cloud computing device A 204A to one or more other cloud computing devices 204.

At step 710, a workload migration plan, including monitoring and error handling, is invoked. For example, as shown in FIGS. 1, migration implementer 120 implements the migration plan created by migration planner 118 by stopping logic to be migrated (source logic) on one or more source computing devices, instantiating, configuring and starting migrated query logic (target logic) on one or more target computing devices. Migration implementer 120 may determine logic nodes affected by the migration plan, stop the one or more source query logic nodes affected by the workload migration plan, checkpoint the stopped source query logic node to create a snapshot of a state of the at one or more source query logic nodes, create one or more target query logic nodes (e.g. instances of query logic nodes) with a configuration and connections matching a configuration and connections (e.g. graph topology) of the at least one source query logic node; provide the one or more target query logic nodes with the state of the one or more source query nodes from the checkpoint; and start the one or more target query logic nodes. With reference to the example in FIG. 2A, given that the analysis determined that edge computing devices 204 cannot handle the computational load, the migration plan plans to migrate first and second pipelines 206, 208 to one or more cloud computing devices 204 and, if necessary, migrate third and fourth pipelines 210, 212 from cloud computing device A to one or more other cloud computing devices 204. Migration implementer 120 would invoke this plan. Error handling for migration may comprise, for example, attempting one or more retries to overcome a failure, up to a maximum number of retries or timeout. A successful retry may, for example, result in continuing migration or, if migration is complete, returning to migration criteria analysis. An unsuccessful retry may, for example, result in a rollback to pre-migration status (e.g. restarting stopped logic) and returning to migration analysis.

FIG. 8 is a flowchart of an example method for data streaming workload migration in accordance with an example embodiment. Embodiments disclosed herein and other embodiments may operate in accordance with method 800. Method 800 comprises steps 802 to 810. However, other embodiments may operate according to other methods. Other structural and operational embodiments will be apparent to persons skilled in the relevant art(s) based on the foregoing discussion of embodiments. No order of steps is required unless expressly indicated or inherently required. There is no requirement that a method embodiment implement all of the steps illustrated in FIG. 8. FIG. 8 is simply one of many possible embodiments. Embodiments may implement fewer, more or different steps.

Method 800 begins with step 802. In step 802, workload performance and periodically updated workload migration criteria are analyzed to determine that: (1) the network between cloud and edge is unreliable/intermittent; and (2) edge computing devices have capacity for migrated logic. For example, as shown in FIG. 1, migration criteria analyzer 116 analyzes workload performance statistics 127 and criteria 126 periodically collected by data collector 122 and stored in storage 108 to determine that: (1) the network between cloud and edge is unreliable/intermittent; and (2) edge computing devices have capacity for migrated logic.

At steps 804 and 806, a determination is made whether to migrate any part of a deployed workload based on: (1) the analysis at step 802 or (2) user defined migration 806. For example, as shown in FIG. 1, migration criteria analyzer 116 determines whether to migrate any part of a deployed workload based on the analysis or based on user-defined migration provided by a customer computing device among customer computing devices 128. The procedure proceeds to migration planning step 808, for example, based on criteria analyzer 116 determining that (1) the network between cloud and edge is unreliable/intermittent; and (2) edge computing devices have capacity for migrated logic.

At step 808, a workload migration plan is created to move at least a portion of logic from source to target cloud device(s) and/or edge device(s) based on the analysis and/or user-defined migration. For example, as shown in FIG. 1, migration planner 118 creates a workload migration plan to move at least a portion of deployed logic based on the analysis and/or user-defined migration. With reference to the example shown in FIG. 2A, given that the analysis determined that the network between cloud and edge is unreliable/intermittent and edge computing devices have capacity for migrated logic, the migration plan would plan to migrate third and fourth pipelines 210, 212 to one or more edge computing devices 202 and, if necessary, migrate second pipeline 208 from edge computing device A 202A to one or more other edge computing devices 202.

At step 810, a workload migration plan, including monitoring and error handling, is invoked. For example, as shown in FIG. 1, migration implementer 120 implements the migration plan created by migration planner 118 by stopping logic to be migrated (source logic) on one or more source computing devices, instantiating, configuring and starting migrated query logic (target logic) on one or more target computing devices. Migration implementer 120 may determine logic nodes affected by the migration plan, stop the one or more source query logic nodes affected by the workload migration plan, checkpoint the stopped source query logic node to create a snapshot of a state of the at one or more source query logic nodes, create one or more target query logic nodes (e.g. instances of query logic nodes) with a configuration and connections matching a configuration and connections (e.g. graph topology) of the at least one source query logic node; provide the one or more target query logic nodes with the state of the one or more source query nodes from the checkpoint; and start the one or more target query logic nodes. With reference to the example in FIG. 2A, given that the analysis determined that the network between cloud and edge is unreliable/intermittent and edge computing devices have capacity for migrated logic, the migration plan plans to migrate third and fourth pipelines 210, 212 to one or more edge computing devices 202 and, if necessary, migrate second pipeline 208 from edge computing device A 202A to one or more other edge computing devices 202. Migration implementer 120 would invoke this plan. Error handling for migration may comprise, for example, attempting one or more retries to overcome a failure, up to a maximum number of retries or timeout. A successful retry may, for example, result in continuing migration or, if migration is complete, returning to migration criteria analysis. An unsuccessful retry may, for example, result in a rollback to pre-migration status (e.g. restarting stopped logic) and returning to migration analysis.

III. Example Mobile Device and Computing Device Embodiments

Embodiments described herein may be implemented in hardware, or hardware combined with software and/or firmware. For example, embodiments described herein may be implemented as computer program code/instructions configured to be executed in one or more processors and stored in a computer readable storage medium. Alternatively, embodiments described herein may be implemented as hardware logic/electrical circuitry.

As noted herein, the embodiments described, including in FIGS. 1-8, along with any modules, components and/or subcomponents thereof, as well as the flowcharts/flow diagrams described herein, including portions thereof, and/or further examples described herein, may be implemented in hardware, or hardware with any combination of software and/or firmware, including being implemented as computer program code configured to be executed in one or more processors and stored in a computer readable storage medium, or being implemented as hardware logic/electrical circuitry, such as being implemented together in a system-on-chip (SoC), a field programmable gate array (FPGA), and/or an application specific integrated circuit (ASIC). A SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

Embodiments described herein may be implemented in one or more computing devices similar to a mobile system and/or a computing device in stationary or mobile computer embodiments, including one or more features of mobile systems and/or computing devices described herein, as well as alternative features. The descriptions of mobile systems and computing devices provided herein are provided for purposes of illustration, and are not intended to be limiting. Embodiments may be implemented in further types of computer systems, as would be known to persons skilled in the relevant art(s).

FIG. 9 is a block diagram of an exemplary mobile system 900 that includes a mobile device 902 that may implement embodiments described herein. For example, mobile device 902 may be used to implement any system, client, or device, or components/subcomponents thereof, in the preceding sections. As shown in FIG. 9, mobile device 902 includes a variety of optional hardware and software components. Any component in mobile device 902 can communicate with any other component, although not all connections are shown for ease of illustration. Mobile device 902 can be any of a variety of computing devices (e.g., cell phone, smart phone, handheld computer, Personal Digital Assistant (PDA), etc.) and can allow wireless two-way communications with one or more mobile communications networks 904, such as a cellular or satellite network, or with a local area or wide area network.

Mobile device 902 can include a controller or processor 910 (e.g., signal processor, microprocessor, ASIC, or other control and processing logic circuitry) for performing such tasks as signal coding, data processing, input/output processing, power control, and/or other functions. An operating system 912 can control the allocation and usage of the components of mobile device 902 and provide support for one or more application programs 914 (also referred to as “applications” or “apps”). Application programs 914 may include common mobile computing applications (e.g., e-mail applications, calendars, contact managers, web browsers, messaging applications) and any other computing applications (e.g., word processing applications, mapping applications, media player applications).

Mobile device 902 can include memory 920. Memory 920 can include non-removable memory 922 and/or removable memory 924. Non-removable memory 922 can include RAM, ROM, flash memory, a hard disk, or other well-known memory devices or technologies. Removable memory 924 can include flash memory or a Subscriber Identity Module (SIM) card, which is well known in GSM communication systems, or other well-known memory devices or technologies, such as “smart cards.” Memory 920 can be used for storing data and/or code for running operating system 912 and application programs 914. Example data can include web pages, text, images, sound files, video data, or other data to be sent to and/or received from one or more network servers or other devices via one or more wired or wireless networks. Memory 920 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

A number of programs may be stored in memory 920. These programs include operating system 912, one or more application programs 914, and other program modules and program data. Examples of such application programs or program modules may include, for example, computer program logic (e.g., computer program code or instructions) for implementing system 100 of FIG. 1, along with any components and/or subcomponents thereof, as well as the flowcharts/flow diagrams described herein, including portions thereof, and/or further examples described herein.

Mobile device 902 can support one or more input devices 930, such as a touch screen 932, a microphone 934, a camera 936, a physical keyboard 938 and/or a trackball 940 and one or more output devices 950, such as a speaker 952 and a display 954. Other possible output devices (not shown) can include piezoelectric or other haptic output devices. Some devices can serve more than one input/output function. For example, touch screen 932 and display 954 can be combined in a single input/output device. Input devices 930 can include a Natural User Interface (NUI).

One or more wireless modems 960 can be coupled to antenna(s) (not shown) and can support two-way communications between processor 910 and external devices, as is well understood in the art. Modem 960 is shown generically and can include a cellular modem 966 for communicating with the mobile communication network 904 and/or other radio-based modems (e.g., Bluetooth 964 and/or Wi-Fi 962). At least one wireless modem 960 is typically configured for communication with one or more cellular networks, such as a GSM network for data and voice communications within a single cellular network, between cellular networks, or between the mobile device and a public switched telephone network (PSTN).

Mobile device 902 can further include at least one input/output port 980, a power supply 982, a satellite navigation system receiver 984, such as a Global Positioning System (GPS) receiver, an accelerometer 986, and/or a physical connector 990, which can be a USB port, IEEE 994 (FireWire) port, and/or RS-232 port. The illustrated components of mobile device 902 are not required or all-inclusive, as any components can be deleted and other components can be added as would be recognized by one skilled in the art.

In an embodiment, mobile device 902 is configured to implement any of the above-described features of flowcharts herein. Computer program logic for performing any of the operations, steps, and/or functions described herein may be stored in memory 920 and executed by processor 910.

FIG. 10 depicts an exemplary implementation of a computing device 1000 in which embodiments may be implemented. For example, embodiments described herein may be implemented in one or more computing devices similar to computing device 1000 in stationary or mobile computer embodiments, including one or more features of computing device 1000 and/or alternative features. The description of computing device 1000 provided herein is provided for purposes of illustration, and is not intended to be limiting. Embodiments may be implemented in further types of computer systems and/or game consoles, etc., as would be known to persons skilled in the relevant art(s).

As shown in FIG. 10, computing device 1000 includes one or more processors, referred to as processor circuit 1002, a system memory 1004, and a bus 1006 that couples various system components including system memory 1004 to processor circuit 1002. Processor circuit 1002 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 1002 may execute program code stored in a computer readable medium, such as program code of operating system 1030, application programs 1032, other programs 1034, etc. Bus 1006 represents one or more of any of several types of bus structures, including a memory bus or memory controller, a peripheral bus, an accelerated graphics port, and a processor or local bus using any of a variety of bus architectures. System memory 1004 includes read only memory (ROM) 1008 and random access memory (RAM) 1010. A basic input/output system 1012 (BIOS) is stored in ROM 1008.

Computing device 1000 also has one or more of the following drives: a hard disk drive 1014 for reading from and writing to a hard disk, a magnetic disk drive 1016 for reading from or writing to a removable magnetic disk 1018, and an optical disk drive 1020 for reading from or writing to a removable optical disk 1022 such as a CD ROM, DVD ROM, or other optical media. Hard disk drive 1014, magnetic disk drive 1016, and optical disk drive 1020 are connected to bus 1006 by a hard disk drive interface 1024, a magnetic disk drive interface 1026, and an optical drive interface 1028, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 1030, one or more application programs 1032, other programs 1034, and program data 1036. Application programs 1032 or other programs 1034 may include, for example, computer program logic (e.g., computer program code or instructions) for implementing embodiments described herein, along with any modules, components and/or subcomponents thereof, as well as the flowcharts/flow diagrams described herein, including portions thereof, and/or further examples described herein.

A user may enter commands and information into the computing device 1000 through input devices such as keyboard 1038 and pointing device 1040. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 1002 through a serial port interface 1042 that is coupled to bus 1006, but may be connected by other interfaces, such as a parallel port, game port, or a universal serial bus (USB).

A display screen 1044 is also connected to bus 1006 via an interface, such as a video adapter 1046. Display screen 1044 may be external to, or incorporated in computing device 1000. Display screen 1044 may display information, as well as being a user interface for receiving user commands and/or other information (e.g., by touch, finger gestures, virtual keyboard, etc.). In addition to display screen 1044, computing device 1000 may include other peripheral output devices (not shown) such as speakers and printers.

Computing device 1000 is connected to a network 1048 (e.g., the Internet) through an adaptor or network interface 1050, a modem 1052, or other means for establishing communications over the network. Modem 1052, which may be internal or external, may be connected to bus 1006 via serial port interface 1042, as shown in FIG. 10, or may be connected to bus 1006 using another interface type, including a parallel interface.

As used herein, the terms “computer program medium,” “computer-readable medium,” and “computer-readable storage medium,” etc., are used to refer to physical hardware media. Examples of such physical hardware media include the hard disk associated with hard disk drive 1014, removable magnetic disk 1018, removable optical disk 1022, other physical hardware media such as RAMs, ROMs, flash memory cards, digital video disks, zip disks, MEMs, nanotechnology-based storage devices, and further types of physical/tangible hardware storage media (including memory 1020 of FIG. 10). Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 1032 and other programs 1034) may be stored on the hard disk, magnetic disk, optical disk, ROM, RAM, or other hardware storage medium. Such computer programs may also be received via network interface 1050, serial port interface 1042, or any other interface type. Such computer programs, when executed or loaded by an application, enable computing device 1000 to implement features of embodiments discussed herein. Accordingly, such computer programs represent controllers of the computing device 1000.

Embodiments are also directed to computer program products comprising computer code or instructions stored on any computer-readable medium or computer-readable storage medium. Such computer program products include hard disk drives, optical disk drives, memory device packages, portable memory sticks, memory cards, and other types of physical storage hardware.

### IV. Additional Exemplary Embodiments

Methods, systems, and computer program products are described herein for automated cloud-edge workload distribution and bidirectional migration with lossless, once-only data stream processing. A cloud service may provide workload and bidirectional migration management between cloud and edge to provide once-only processing of data streams before and after migration. Migrated logic nodes may begin processing data streams where processing stopped at source logic nodes before migration without data loss or repetition, for example, by migrating and using anchors in pull-based stream processing. Query logic implementing customer queries of data streams may be distributed to edge and/or cloud devices based on placement criteria. Query logic may be migrated from source to target edge and/or cloud devices based on migration criteria.

In an example, a system may comprise, for example, a processing system that includes one or more processors and a memory configured to store program code for execution by the processing system, the program code being configured to manage placement and migration of data streaming workloads distributed among cloud and edge computing devices, with once-only streaming data processing before and after migration of the data streaming workloads.

In an example, the aforementioned program code may comprise a streaming workload placement manager and a streaming workload migration manager. In an example, the streaming workload placement manager may be configured to, for example, receive a query pertaining to at least one data stream; determine a workload comprising query logic to implement the query; create, based on an analysis of the workload and workload placement criteria, a workload placement plan to deploy the query logic; and invoke the workload placement plan to create a deployed workload that provides once-only streaming data processing of the at least one data stream based on the query logic. In an example, the streaming workload migration manager may be configured to, for example, monitor the deployed workload, e.g., by analyzing workload performance statistics and workload migration criteria to determine whether to migrate at least a portion of the deployed workload; create a workload migration plan to migrate deployment of at least a portion of the query logic from at least one migration source to at least one migration target; and invoke the workload migration plan to create a migrated workload that continues providing the once-only streaming data processing of the at least one data stream.

In an example, the once-only streaming data processing of at least one data stream may comprise, for example, processing the at least one data stream with pull-based, once-only processing using anchors that describe points in the at least one data stream.

In an example, the streaming workload migration manager is configured to invoke the workload migration plan by, for example, stopping at least one source query logic node affected by the workload migration plan; checkpointing the at least one source query logic node to create a snapshot of a state of the at least one source query logic node; creating at least one target query logic node with a configuration and connections matching a configuration and connections of the at least one source query logic node; providing the at least one target query logic node with the state of the at least one source query logic node from the checkpoint; and starting the at least one target query logic node.

In an example, the at least one source query logic node may comprise, for example, a source upstream node and a source output node. The at least one target query logic node may comprise, for example, a target upstream node and a target output node. Providing the at least one target query logic node with the state of the at least one source query logic node from the checkpoint may comprise, for example, assigning an anchor for the source output node as an anchor of the target output node; providing, by the target output node, the anchor to the target upstream node; providing a state of the source upstream node to the target upstream node by using the anchor provided by the target output node to access the checkpoint; and pulling data, by the target output node, from the target upstream node, that was not pulled by the source output node from the source upstream node to provide once-only processing of the at least one data stream before and after migration.

In an example, a method performed by at least one computing device may comprise, for example, receiving, by a cloud service, a query pertaining to at least one data stream; determining a workload comprising query logic to implement the query; analyzing the workload and workload placement criteria; creating, based on the analysis, a workload placement plan to deploy the query logic by selecting between an edge deployment, a cloud deployment and a split/hybrid deployment on cloud and edge; and invoking the workload placement plan to create a deployed workload that provides stream processing of the at least one data stream based on the query logic.

In an example, the deployed workload may comprise a split/hybrid deployment on cloud and edge.

In an example, invoking the workload placement plan to create the deployed workload that provides the stream processing of the at least one data stream may comprise, for example, invoking the workload placement plan to create the deployed workload that provides the stream processing of the at least one data stream with pull-based, once-only processing using anchors that describe points in the at least one data stream.

In an example, the method may (e.g. further) comprise, for example, monitoring the deployed workload by analyzing workload performance statistics and workload migration criteria to determine whether to migrate at least a portion of the deployed workload.

In an example, the workload migration criteria may comprise, for example, one or more of: edge and cloud communication quality; edge load or capacity; cloud load or capacity; a workload performance requirement; cost of cloud workload deployment; or customer constraints.

In an example, the method may (e.g. further) comprise, for example, migrating at least a portion of the deployed workload from edge to cloud, from edge to edge and cloud, from cloud to edge, or from cloud to cloud and edge based on user-defined migration instructions.

In an example, the method may (e.g. further) comprise, for example, determining, e.g., based on the analysis of workload performance statistics and the workload migration criteria, that at least a portion of the deployed workload qualifies to be migrated from edge to cloud, from edge to edge and cloud, from cloud to edge, or from cloud to cloud and edge.

In an example, the method may (e.g. further) comprise, for example, creating a workload migration plan to migrate deployment of at least a portion of the query logic from at least one migration source to at least one migration target, e.g., comprising at least one of the following: edge to edge, edge to cloud, edge to edge and cloud, cloud to cloud, cloud to edge, cloud to cloud and edge; and invoking the workload migration plan.

In an example, invoking the workload migration plan may comprise, for example, stopping at least one source query logic node affected by the workload migration plan; checkpointing the at least one source query logic node to create a snapshot of a state of the at least one source query logic node; creating at least one target query logic node with a configuration and connections matching a configuration and connections of the at least one source query logic node; providing the at least one target query logic node with the state of the at least one source query logic node from the checkpoint; and starting the at least one target query logic node.

In an example, the at least one source query logic node may comprise, for example, a source upstream node and a source output node. The at least one target query logic node may comprise, for example, a target upstream node and a target output node. Providing the at least one target query logic node with the state of the at least one source query logic node from the checkpoint may comprise, for example, assigning an anchor for the source output node as an anchor of the target output node; providing, by the target output node, the anchor to the target upstream node; and providing a state of the source upstream node to the target upstream node by using the anchor provided by the target output node to access the checkpoint

In an example, the method may (e.g. further) comprise the target output node pulling data from the target upstream node, where the data was not pulled by the source output node from the source upstream node, as an example, of providing once-only processing of the at least one data stream before and after migration.

In an example, at least one data stream may comprise, for example, personally identifiable information (PII). The workload placement plan may, for example, split deployment of query logic between the cloud and edge, restricting processing of the PII to the edge, e.g., based on workload placement criteria specifying a customer constraint for PII handling.

In an example, a computer-readable storage medium may have program instructions recorded thereon that, when executed by a processing circuit, perform a method comprising, for example, monitoring a data stream processing workload comprising workload logic deployed among edge and cloud computing devices by analyzing workload performance statistics and workload migration criteria to determine whether to migrate at least a portion of the workload logic, the workload logic providing once-only streaming data processing of at least one data stream; creating, based on the analysis, a workload migration plan to migrate at least a portion of the workload logic from at least one migration source to at least one migration target; and invoking the workload migration plan to create a migrated workload comprising migrated logic that continues providing the once-only streaming data processing of the at least one data stream.

In an example, the migrated workload migrates at least a portion of the deployed workload from edge to cloud, from edge to edge and cloud, from cloud to edge, or from cloud to cloud and edge.

In an example, invoking the workload migration plan may comprise, for example, stopping at least one source workload logic node affected by the workload migration plan; checkpointing the at least one source workload logic node to create a snapshot of a state of the at least one source workload logic node; creating at least one target workload logic node with a configuration and connections matching a configuration and connections of the at least one source workload logic node; providing the at least one target workload logic node with the state of the at least one source workload logic node from the checkpoint; and starting the at least one target workload logic node.

### V. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method performed by at least one computing device, comprising:
receiving, by a cloud service, a query pertaining to at least one data stream;
determining a workload comprising query logic to implement the query;
analyzing the workload and workload placement criteria;
creating, based on the analysis, a workload placement plan to deploy the query logic by selecting between an edge deployment, a cloud deployment and a split deployment on cloud and edge; and
invoking the workload placement plan to create a deployed workload that provides stream processing of the at least one data stream based on the query logic.

2. The method of claim 1, wherein the deployed workload comprises a split deployment on cloud and edge.

3. The method of claim 2, wherein invoking the workload placement plan to create the deployed workload that provides the stream processing of the at least one data stream comprises:
invoking the workload placement plan to create the deployed workload that provides the stream processing of the at least one data stream with pull-based, once-only processing using anchors that describe points in the at least one data stream.

4. The method of claim 3, further comprising:
monitoring the deployed workload by analyzing workload performance statistics and workload migration criteria to determine whether to migrate at least a portion of the deployed workload.

5. The method of claim 4, wherein the workload migration criteria comprises one or more of:
edge and cloud communication quality;
edge load or capacity;
cloud load or capacity;
a workload performance requirement;
cost of cloud workload deployment; or
customer constraints.

6. The method of claim 4, further comprising:
migrating at least a portion of the deployed workload from edge to cloud, from edge to edge and cloud, from cloud to edge, or from cloud to cloud and edge based on user-defined migration instructions.

7. The method of claim 4, further comprising:
determining, based on the analysis of the workload performance statistics and the workload migration criteria, that at least a portion of the deployed workload qualifies to be migrated from edge to cloud, from edge to edge and cloud, from cloud to edge, or from cloud to cloud and edge.

8. The method of claim 7, further comprising:
creating a workload migration plan to migrate deployment of at least a portion of the query logic from at least one migration source to at least one migration target comprising at least one of the following: edge to edge, edge to cloud, edge to edge and cloud, cloud to cloud, cloud to edge, cloud to cloud and edge; and
invoking the workload migration plan.

9. A method of claim 8, wherein invoking the workload migration plan comprises:
stopping at least one source query logic node affected by the workload migration plan;
checkpointing the at least one source query logic node to create a snapshot of a state of the at least one source query logic node;
creating at least one target query logic node with a configuration and connections matching a configuration and connections of the at least one source query logic node;
providing the at least one target query logic node with the state of the at least one source query logic node from the checkpoint; and
starting the at least one target query logic node.

10. The method of claim 9, the at least one source query logic node comprising a source upstream node and a source output node and the at least one target query logic node comprising a target upstream node and a target output node, wherein the providing of the at least one target query logic node with the state of the at least one source query logic node from the checkpoint comprises:
assigning an anchor for the source output node as an anchor of the target output node;
providing, by the target output node, the anchor to the target upstream node; and
providing a state of the source upstream node to the target upstream node by using the anchor provided by the target output node to access the checkpoint.

11. The method of claim 10, further comprising:
pulling data, by the target output node, from the target upstream node, that was not pulled by the source output node from the source upstream node to provide once-only processing of the at least one data stream before and after migration.

12. The method of claim 1, the at least one data stream comprising personally identifiable information (PII), wherein the workload placement plan splits deployment of the query logic between the cloud and edge, restricting processing of the PII to the edge based on the workload placement criteria comprising a customer constraint for PII handling.

13. A system comprising:
a processing system that includes one or more processors; and
a memory configured to store program code for execution by the processing system, the program code being configured to manage placement and migration of data streaming workloads distributed among cloud and edge computing devices, with once-only streaming data processing before and after migration of the data streaming workloads.

14. The system of claim 13, wherein the program code comprises:
a streaming workload placement manager configured to:
receive a query pertaining to at least one data stream;
determine a workload comprising query logic to implement the query;
create, based on an analysis of the workload and workload placement criteria, a workload placement plan to deploy the query logic; and
invoke the workload placement plan to create a deployed workload that provides once-only streaming data processing of the at least one data stream based on the query logic; and
a streaming workload migration manager configured to:
monitor the deployed workload by analyzing workload performance statistics and workload migration criteria to determine whether to migrate at least a portion of the deployed workload;
create a workload migration plan to migrate deployment of at least a portion of the query logic from at least one migration source to at least one migration target; and
invoke the workload migration plan to create a migrated workload that continues providing the once-only streaming data processing of the at least one data stream.

15. The system of claim 14, wherein the once-only streaming data processing of the at least one data stream comprises:
processing the at least one data stream with pull-based, once-only processing using anchors that describe points in the at least one data stream.

16. The system of claim 15, wherein the streaming workload migration manager is configured to invoke the workload migration plan by:
stopping at least one source query logic node affected by the workload migration plan;
checkpointing the at least one source query logic node to create a snapshot of a state of the at least one source query logic node;
creating at least one target query logic node with a configuration and connections matching a configuration and connections of the at least one source query logic node;
providing the at least one target query logic node with the state of the at least one source query logic node from the checkpoint; and
starting the at least one target query logic node.

17. The system of claim 16, wherein the at least one source query logic node comprises a source upstream node and a source output node and the at least one target query logic node comprises a target upstream node and a target output node, and wherein the providing of the at least one target query logic node with the state of the at least one source query logic node from the checkpoint comprises:
assigning an anchor for the source output node as an anchor of the target output node;
providing, by the target output node, the anchor to the target upstream node;
providing a state of the source upstream node to the target upstream node by using the anchor provided by the target output node to access the checkpoint; and
pulling data, by the target output node, from the target upstream node, that was not pulled by the source output node from the source upstream node to provide once-only processing of the at least one data stream before and after migration.

18. A computer-readable storage medium having program instructions recorded thereon that, when executed by a processing circuit, perform a method comprising:
monitoring a data stream processing workload comprising workload logic deployed among edge and cloud computing devices by analyzing workload performance statistics and workload migration criteria to determine whether to migrate at least a portion of the workload logic, the workload logic providing once-only streaming data processing of at least one data stream;
creating, based on the analysis, a workload migration plan to migrate at least a portion of the workload logic from at least one migration source to at least one migration target; and
invoking the workload migration plan to create a migrated workload comprising migrated logic that continues providing the once-only streaming data processing of the at least one data stream.

19. The computer-readable storage medium of claim 18, wherein the migrated workload migrates at least a portion of the deployed workload from edge to cloud, from edge to edge and cloud, from cloud to edge, or from cloud to cloud and edge.

20. The computer-readable storage medium of claim 18, wherein invoking the workload migration plan comprises:
stopping at least one source workload logic node affected by the workload migration plan;
checkpointing the at least one source workload logic node to create a snapshot of a state of the at least one source workload logic node;
creating at least one target workload logic node with a configuration and connections matching a configuration and connections of the at least one source workload logic node;
providing the at least one target workload logic node with the state of the at least one source workload logic node from the checkpoint; and
starting the at least one target workload logic node.
